(19) United States
(12) Patent Application Publication
(10) Pub. No.: US 2018/0374080 A1
(43) Pub. Date: Dec. 27, 2018

(54) PUBLIC TRANSIT PAYMENT DEVICE

(71) Applicant: Beijing Xiaomi Mobile Software Co., Ltd., Bejing (CN)

(72) Inventors: Kai CHEN, Beijing (CN); Lina XU, Beijing (CN); Wendi HE, Beijing (CN)

(73) Assignee: Beijing Xiaomi Mobile Software Co., Ltd., Bejing (CN)

(21) Appl. No.: 16/010,045

(22) Filed: Jun. 15, 2018

(30) Foreign Application Priority Data
Jun. 22, 2017 (CN) 201710482721.4

(51) Int. Cl. G06Q 20/34

(52) U.S. Cl. CPC G06Q 20/351; G06Q 2240/00; G06Q 20/349; G06Q 20/342

(57) ABSTRACT

A public transit payment device includes a processor, and a memory configured to store instructions executable by the processor. The processor is configured to: perform a public transit payment operation based on a credit line of a public transit credit card, where the public transit credit card is associated with more than one virtual public transit cards that share the credit line of the public transit credit card, receive a public transit credit bill sent from a server, where the public transit credit bill includes consumption bills of the more than one virtual public transit, and create a repayment reminder, where the repayment reminder is used to remind to remit money to a bank account to pay off the public transit credit bill.

### CROSS-REFERENCE TO RELATED APPLICATION

This application is based on and claims the priority to the Chinese patent application No. 201710482721.4 filed on Jun. 22, 2017, the content of which is incorporated herein by reference in its entirety for all purposes.

### TECHNICAL FIELD

The present disclosure relates to the field of terminal application technology, and in particular to the public transit payment device.

### BACKGROUND

Near field communication (NFC) has gradually become a standard configuration of mobile phones of various mobile phone manufacturers. It is a favorite function to provide the user with public transit card service through a card simulation function of the NFC of the mobile phone, which is also a field where domestic and foreign mobile phone manufacturers, even including bank card organizations, quickly follow up and compete fiercely.

### SUMMARY

The present disclosure provides public transit payment devices.

According to a first aspect of present disclosure, a public transit payment device is provided. The device may include a processor, and a memory configured to store instructions executable by the processor.

The processor may be configured to perform a public transit payment operation based on a credit line of a public transit credit card, where the public transit credit card is associated with more than one virtual public transit cards, and the more than one virtual public transit cards that are associated with the public transit credit card share the credit line of the public transit credit card, receive a public transit credit bill sent from a server, where the public transit credit bill includes consumption bills of the more than one virtual public transit cards that are associated with the public transit credit card, and create a repayment reminder, where the repayment reminder is used to remind to remit money to a bank account that is associated with the server in advance to pay off the public transit credit bill.

According to a second aspect of present disclosure, a public transit payment device is provided. The device may include a processor, and a memory configured to store instructions executable by the processor.

The processor may be configured to receive consumption bills of virtual public transit cards sent from transportation card management devices, where each of the transportation card management devices corresponds to one virtual public transit card, and a public transit credit card is associated with the virtual public transit cards and the virtual public transit cards that are associated with the public transit credit card share a credit line of the public transit credit card, and send a public transit credit bill to a terminal, where the public transit credit bill includes the consumption bills of the virtual public transit cards that are associated with the public transit credit card and is used to remind to remit money to a bank account that is associated with a server in advance to pay off the public transit credit bill.

According to a third aspect of present disclosure, a public transit payment device is provided. The device may include a processor, and a memory configured to store instructions executable by the processor.

The processor may be configured to record a consumption amount, corresponding to a public transit payment operation which is performed using a first virtual public transit card associated with a public transit credit card, in a consumption bill of the first virtual public transit card, where the public transit credit card is associated with more than one virtual public transit cards and the more than one virtual public transit cards that are associated with the public transit credit card share a credit line of the public transit credit card, and send the consumption bill of the first virtual public transit card to a server.

It should be understood that the foregoing general description and the following detailed description are exemplary and explanatory only and are not restrictive of the disclosure.

### BRIEF DESCRIPTION OF THE DRAWINGS

The accompanying drawings, which are incorporated in and constitute a part of this specification, illustrate examples consistent with the disclosure and, together with the description, serve to explain the principles of the disclosure.

FIG. 1 is a diagram showing an application scenario of a public transit payment method according to an example.

FIG. 2 is a flow chart showing a public transit payment method according to an example.

FIG. 3 is a flow chart showing a public transit payment method according to an example.

FIG. 4 is a flow chart showing a public transit payment method according to an example.

FIG. 5 is a flow chart showing a public transit payment method according to an example.

FIG. 6 is a flow chart showing a public transit payment method according to an example.

FIG. 7 is a block diagram illustrating a public transit payment device according to an example.

FIG. 8 is a block diagram illustrating a public transit payment device according to an example.

FIG. 9 is a block diagram illustrating a public transit payment device according to an example.

FIG. 10 is a block diagram illustrating a public transit payment device according to an example.

FIG. 11 is a block diagram illustrating a public transit payment device according to an example.

FIG. 12 is a block diagram illustrating a public transit payment device according to an example.

FIG. 13 is a block diagram illustrating a public transit payment device according to an example.

FIG. 14 is a block diagram illustrating a public transit payment device according to an example.

FIG. 15 is a block diagram illustrating a public transit payment device according to an example.

FIG. 16 is a block diagram illustrating a public transit payment device according to an example.

FIG. 17 is a block diagram illustrating a public transit payment device according to an example.

FIG. 18 is a block diagram illustrating a public transit payment device according to an example.

FIG. 19 is a block diagram illustrating a public transit payment device according to an example.

FIG. 20 is a block diagram illustrating a public transit payment device according to an example.

FIG. 21 is a block diagram illustrating a public transit payment device according to an example.

FIG. 22 is a block diagram illustrating a public transit payment device according to an example.

FIG. 23 is a block diagram illustrating a public transit payment device according to an example.

FIG. 24 is a block diagram illustrating a public transit payment device according to an example.

FIG. 25 is a block diagram illustrating a public transit payment device according to an example.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various examples of the present disclosure. Also, common but well-understood elements that are useful or necessary in a commercially feasible example are often not depicted in order to facilitate a less obstructed view of these various examples. It will further be appreciated that certain actions and/or steps may be described or depicted in a particular order of occurrence while those skilled in the art will understand that such specificity with respect to sequence is not actually required. It will also be understood that the terms and expressions used herein have the ordinary technical meaning as is accorded to such terms and expressions by persons skilled in the technical field as set forth above, except where different specific meanings have otherwise been set forth herein.

### DETAILED DESCRIPTION

Reference will now be made in detail to examples, examples of which are illustrated in the accompanying drawings. The following description refers to the accompanying drawings in which the same numbers in different drawings represent the same or similar elements unless otherwise indicated. The implementations set forth in the following description of examples do not represent all implementations consistent with the disclosure.

The terminology used in the present disclosure is for the purpose of describing exemplary examples only and is not intended to limit the present disclosure. As used in the present disclosure and the appended claims, the singular forms “a,” “an” and “the” are intended to include the plural forms as well, unless the context clearly indicates otherwise. It shall also be understood that the terms “or” and “and/or” used herein are intended to signify and include any or all possible combinations of one or more of the associated listed items, unless the context clearly indicates otherwise.

It shall be understood that, although the terms “first,” “second,” “third,” etc. may be used herein to describe various information, the information should not be limited by these terms. These terms are only used to distinguish one category of information from another. For example, without departing from the scope of the present disclosure, first information may be termed as second information; and similarly, second information may also be termed as first information. As used herein, the term “if” may be understood to mean “when” or “upon” or “in response to” depending on the context.

For a terminal such as a mobile phone, one way in which the mobile phone accesses to public transit card companies, usually includes: connecting one by one transportation card management devices of various cities, and showing public transit services of these cities together to a user through a wallet client. What the user may see on the mobile phone includes entries of virtual public transit cards of several cities, the user may select a desired city for performing an issuance of a public transit card, recharge and installation of the virtual public transit card of this city to the mobile phone of the user. Then, the user can use the municipal public transit service in this city. Every time the user goes to a new city, the user may install a local virtual public transit card and may use the local virtual public transit card after the local virtual public transit card is recharged.

Sometimes, public transit service capabilities are moved from offline to online, and the user can touch it through the mobile phone. By collecting fragmented information as a whole and gathering dispersive information, the user may open the public transit services of several cities in a mobile phone client. However, the this method may be a simple and blunt copy of the off-line public transit payment mode, and the user can use the public transit service of each city only after the user has manually recharged each virtual public transit card, thus, the operation process is complicated and cumbersome and user experience is poor.

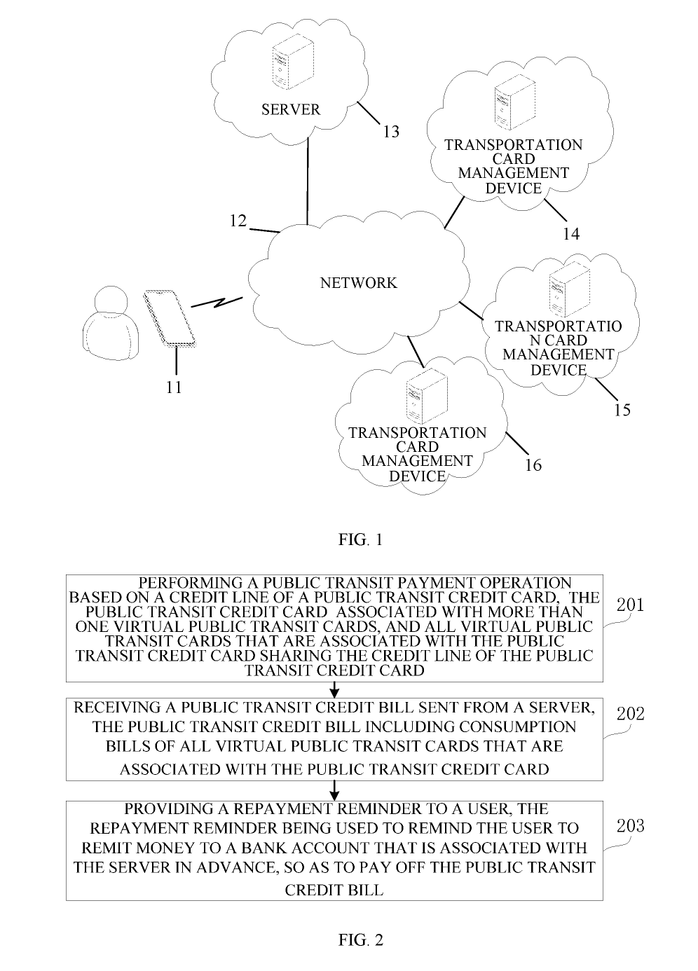

FIG. 1 is a diagram showing an optional application scenario of a public transit payment method according to an example of the present disclosure. The application scenario shown in FIG. 1 includes a terminal 11, a network 12, a server 13, a transportation card management device 14, a transportation card management device 15 and a transportation card management device 16. The terminal 11, the server 13, the transportation card management device 14, the transportation card management device 15 and the transportation card management device 16 are communicated and exchange data through the network 12. The network 12 may be a wired network or a wireless network. The transportation card management device 14, the transportation card management device 15 and the transportation card management device 16 may be transportation card management devices of three different cities, respectively.

Sometimes, the server 13 for public transit payment service is connected one by one to transportation card management devices of various cities for public transit payment service. The background server 13 uses the terminal 11 or a terminal application (such as a wallet client) to show public transit services of various cities together to a user. A user interface of the terminal 11 shows an entry of virtual public transit card of each city. When the user goes to a new city, the user may need to manually select an entry of a virtual public transit card for this city so as to perform a card issuance and a recharge process for this virtual public transit card, so that the terminal obtains the virtual public transit card for this city and then the user can use the municipal public transit service in this city. As can be seen, when adopting this method, the user can use the public transit service of each city after the user has manually recharged each virtual public transit card, thus, the operation process seems complicated and cumbersome and user experience is poor.

It should be noted, the application scenario shown in FIG. 1 is merely one possible exemplary application scenario of technical solutions of examples of the present disclosure, and the application scenario shown in FIG. 1 includes the transportation card management devices of three cities as an example, and other application scenario may include devices not shown in FIG. 1 and transportation card management devices of any number of cities.

The technical solutions described in examples of the present disclosure can be applied to the above application scenario, so as to help to overcome the problems that the operation process is complicated and cumbersome, the efficiency is low, the user is inconvenient to use and the maintenance cost is high, which consumes a lot of money and energy, and the user experience is poor.

In order to solve the above problems, one example of the present disclosure provides a public transit payment method, including: performing a public transit payment operation based on a credit line of a public transit credit card, where the public transit credit card is associated with more than one virtual public transit cards, and all virtual public transit cards that are associated with the public transit credit card share the credit line of the public transit credit card; receiving a public transit credit bill sent from a server, where the public transit credit bill includes consumption bills of all virtual public transit cards that are associated with the public transit credit card; providing a repayment reminder to a user, where the repayment reminder is used to remind the user to remit money to a bank account that is associated with the server in advance, so as to pay off the public transit credit bill. In the technical solution provided in this example of the present disclosure, the public transit payment operation is performed based on the public transit credit card having a credit line, and the public transit credit bill is paid off in time when the public transit credit bill is received. Thus, the user does not need to manually recharge a variety of virtual public transit cards associated with the public transit credit card, thereby simplifying operations of the user and improving user experience. It should be noted, the terminal of one example of the present disclosure may be user equipment such as a smart phone, a tablet computer, a desktop computer, a notebook computer, or a wearable device.

Base on the application scenario described above, the following specific examples are provided.

FIG. 2 is a flow chart showing a public transit payment method according to an example, and an execution subject of the method may be a terminal. As shown in FIG. 2, the method includes the following steps 201 to 203.

In step 201, a public transit payment operation is performed based on a credit line of a public transit credit card. The public transit credit card is associated with more than one virtual public transit cards, and all virtual public transit cards that are associated with the public transit credit card share the credit line of the public transit credit card.

As an example, a server opens a public transit credit card with a credit line for a user in advance, and all virtual public transit cards that are associated with the public transit credit card share the credit line of the public transit credit card. For example, the terminal sends an account application to the server which is used to request the server to open a public transit credit card for the terminal. The server acquires the user's avatar and credit records and issues a virtual public transit credit card for the user and grants a certain credit line to the public transit credit card. The server sends an account opening response to the terminal, and the account opening response includes the credit line granted by the server to the public transit credit card. The terminal receives the account opening response returned from the server, and parses the account opening response to obtain the public transit credit card and its credit line. The terminal obtains and stores more than one virtual public transit cards, associates the public transit credit card with the virtual public transit cards. All virtual public transit cards that are associated with the public transit credit card share the credit line of the public transit credit card.

In actual application, implementation modes in which the terminal obtains and stores more than one virtual public transit cards at least include any one of the following modes or a combination thereof

Mode one: the terminal acquires address information of the user, the address information is associated with the user's historical activity trajectory or the user's schedule; one way for acquiring the address information of the user may include: acquiring address information of the user from a software with positioning function in the terminal, wherein the address information is address information of the user's historical location; or, acquiring, by the terminal, address information of the user from a schedule that is entered by the user, wherein the address information is address information of a position where the user is about to arrive. The terminal obtains and stores the virtual public transit card associated with the address information according to the address information. For example, the terminal sends a request for obtaining virtual public transit card to a transportation card management device corresponding to the address information. The request at least includes identification information of the terminal. After the transportation card management device receives the request, the transportation card management device returns virtual public transit card information to the terminal. The terminal installs a virtual public transit card according to the virtual public transit card information.

Mode two: after the server issues a public transit credit card for a user, the server applies to one transportation card management device to open a virtual public transit card. For the user, the server opens the virtual public transit card of a city where the user is about to arrive or a city where the user often goes. For the user, the server may also open virtual public transit cards of all cities supported by the server or connected with the server. For example, the server applies to the transportation card management device of each city for virtual public transit cards of various cities opened for the user. Each transportation card management device sends virtual public transit card opening information to the terminal. The terminal receives the virtual public transit card opening information sent from the server. The virtual public transit card opening information includes an identifier of at least one virtual public transit card which is opened for the public transit credit card by the server from the transportation card management device.

In step 201, performing the public transit payment operation based on the credit line of the public transit credit card includes: using, by the terminal, a first virtual public transit card associated with the public transit credit card to perform the public transit payment operation, so that the transportation card management device corresponding to the first virtual public transit card records a consumption amount corresponding to the public transit payment operation in a consumption bill of the first virtual public transit card.

As an example, before performing the public transit payment operation, the terminal needs to determine which virtual public transit card to be used in a specific manner which includes one of a manner (a) in which the terminal may acquire a current position and autonomously activate the first virtual public transit card associated with the current position; a manner (b) in which, according to the user's historical activity trajectory or the user's schedule, the terminal may determine in advance a place where the user may go and acquire the virtual public transit card corresponding to this place; and a manner (c) in which the user may manually select one virtual public transit card to be used from more than one virtual public transit cards associated with the public transit credit card on the terminal.

As an example, all virtual public transit cards associated with the public transit credit card may be displayed at a display interface of the terminal, and the user manually selects one virtual public transit card to be used from more than one virtual public transit cards associated with the public transit credit card. Alternatively, the public transit credit card may be displayed at the display interface of the terminal according to pre-configured unified card face information, and more than one virtual public transit cards associated with the public transit credit card are stored locally. The unified card face refers to a pattern or a symbol or the like which is used as a card face of the virtual public transit card for displaying. The unified card face information is preconfigured and is stored in a database. By displaying only the public transit credit card at a user interface of the terminal without directly displaying the virtual public transit cards associated with the public transit credit card at the user interface, the user does not see these virtual public transit cards, and the user only sees one public transit credit card.

In practice, in order to ensure that the user can successfully use the public transit credit card to perform public transit payment, the terminal may check in time a balance of each virtual public transit card associated with the user's public transit credit card. The terminal may also check a balance of the virtual public transit card associated with the current position when the user performs a public transit payment operation. For the virtual public transit card with the balance less than a preset balance threshold, the terminal automatically applies for recharging the virtual public transit card with the balance less than the preset balance threshold. For example, the terminal sends a recharge request to the transportation card management device corresponding to the virtual public transit card via the server, and the transportation card management device increases the balance of the virtual public transit card and sends a recharge response to the terminal. The recharge response carries balance data of the virtual public transit card. Alternatively, the server may determine a balance of each virtual public transit card according to recharge historical data of the user and the consumption bill of each virtual public transit card. When the balance of the first virtual public transit card is less than the preset balance threshold, the server sends a recharge request to the transportation card management device. As an example, the preset balance threshold includes a largest single consumption value of urban traffic, or two times the largest single consumption value of urban traffic. When the preset balance threshold is the largest single consumption value of urban traffic, it can ensure that the public transit payment for a single trip of the user can be successfully completed. When the preset balance threshold is two times the largest single consumption value of urban traffic, it can ensure that the user can go back and forth smoothly.

As an example, the server may detect in time whether an available credit line of the public transit credit card is less than a credit line threshold. The server may also detect whether the available credit line of the public transit credit card is less than the credit line threshold when the user performs the public transit payment operation based on the credit line of the public transit credit card. When the server detects that the available credit line of the public transit credit card is less than the preset credit line threshold, the server sends a reminder instruction to the terminal. When the terminal is informed that the available credit line of the public transit credit card is less than the credit line threshold according to the reminder instruction, the terminal provides a credit line reminder to the user. The credit line reminder is used to remind the user to apply to the server for a higher credit line.

Alternatively, the terminal may send a query request to the server to check the available credit line of the public transit credit card, and provides the credit line reminder to the user when it is determined that the available credit line of the public transit credit card is less than the credit line threshold.

In step 202, a public transit credit bill sent from a server is received. The public transit credit bill includes consumption bills of all virtual public transit cards that are associated with the public transit credit card.

As an example, the server may regularly obtain bills of the public transit credit card from the transportation card management device of each city. The bills of the public transit credit card include consumption bills of all virtual public transit cards associated with the public transit credit card. These consumption bills are obtained by the various transportation card management devices by means of collecting swiping card data of public transit clearing devices such as auto gates. The server sends a public transit credit bill to the terminal. The public transit credit bill includes the consumption bills of all virtual public transit cards that are associated with the public transit credit card. The consumption bills of the virtual public transit cards may record in detail whereabouts of each fee deduction, or may show only a total amount of consumption in each billing statistics cycle. The public transit credit bill sent from the server to the terminal may also include only a total amount of consumption of all virtual public transit cards.

In step 203, a repayment reminder is provided to a user. The repayment reminder is used to remind the user to remit money to a bank account that is associated with the server in advance, so as to pay off the public transit credit bill.

As an example, the terminal receives the public transit credit bill sent from the server, provides the repayment reminder to the user in a reminder mode such as pushing messages or pop-up prompts. The user remits money to the bank account that is associated with the server in advance to pay off the public transit credit card. When the server queries transaction records of the bank account that is associated with the server in advance and then determines that the user has fully paid off the public transit credit bill in time, the server restores a remaining amount of the public transit credit card to the maximum credit line. When the user does not pay off in time, the server may calculate resulting late fees.

In the technical solution provided in this example of the present disclosure, the public transit payment operation is performed based on the credit line of the public transit credit card, and the public transit credit bill is paid off in time when the public transit credit bill is received, and thus each virtual public transit card associated with the public transit credit card can be directly used without being recharged. Therefore, the user does not need to manually recharge each virtual public transit card associated with the public transit credit card, thereby avoiding idle or waste of funds, simplifying operations of the user and improving user experience.

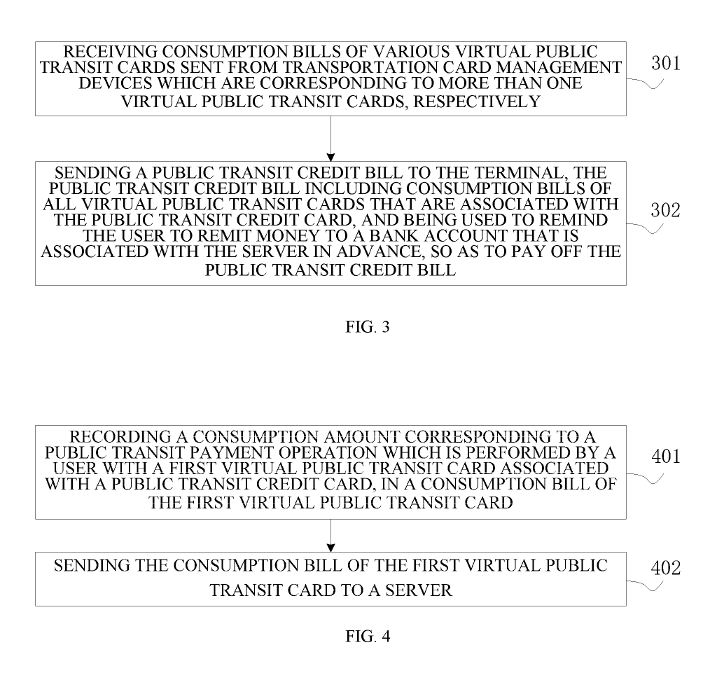

FIG. 3 is a flow chart showing a public transit payment method according to an example, and an execution subject of the method may be a server. As shown in FIG. 3, the method includes the following steps 301 and 302.

In step 301, consumption bills of various virtual public transit cards sent from transportation card management devices which are corresponding to more than one virtual public transit cards, respectively are received. A public transit credit card is associated with the various virtual public transit cards, and all virtual public transit cards that are associated with the public transit credit card share a credit line of the public transit credit card.

As an example, when the server detects that an available credit line of the public transit credit card is less than a preset credit line threshold, the server sends a credit line reminder to a terminal. The credit line reminder is used to remind the user to apply to the server for a higher credit line.

In step 302, a public transit credit bill is sent to the terminal. The public transit credit bill includes consumption bills of all virtual public transit cards that are associated with the public transit credit card, and is used to remind the user to remit money to a bank account that is associated with the server in advance, so as to pay off the public transit credit bill.

As an example, in order to ensure that the user can successfully use the public transit credit card to perform public transit payment, when the server determines that a balance of a first virtual public transit card associated with the public transit credit card is less than a preset balance threshold and an available credit line of the public transit credit card is greater than a preset credit line threshold, the server sends a recharge instruction to the transportation card management device corresponding to the first virtual public transit card. The recharge instruction is used to instruct the transportation card management device to send a recharge response to the terminal, so as to ensure that the balance of the first virtual public transit card is enough for the public transit payment for a single trip of the user, or is enough for the user to go back and forth smoothly.

The server determining that the balance of the first virtual public transit card associated with the public transit credit card is less than the preset balance threshold, for example, may include: determining, by the server, a balance of each virtual public transit card according to recharge historical data of the user and the consumption bill of each virtual public transit card; when the balance of the first virtual public transit card is less than the preset balance threshold, sending, by the server, a recharge request to the transportation card management device. Alternatively, when the server receives from the terminal a first recharge request carrying an identifier of the first virtual public transit card, the server determines that the balance of the first virtual public transit card is less than the preset balance threshold.

An implementation mode in which the server sends the recharge instruction to the transportation card management device corresponding to the first virtual public transit card, may be based on credit modes of the public transit credit card and is as follows.

When the credit mode of the public transit credit card is a simple credit mode, the server remits money to a bank account that is associated with the transportation card management device corresponding to the first virtual public transit card; the server sends a second recharge request to the transportation card management device corresponding to the first virtual public transit card, and the second recharge request includes a remittance voucher and an identifier of the first virtual public transit card. Based on the simple credit mode, the recharge operation process requires the server to advance payment. For example, fee is first deducted from a reserve account of the server rather than from the user's account or funds transferred by the user. Implementation of the recharge process does not need to change the transportation card management device and the recharge process is easy to implement.

When the credit mode of the public transit credit card is a full credit mode, the server sends a third recharge request to the transportation card management device corresponding to the first virtual public transit card, and the third recharge request includes an identifier of the first virtual public transit card. Based on the full credit mode, the recharge operation process does not require the server to advance payment, and the transportation card management device requires the server to pay back money. This reduces transfer of funds, simplifies the process, does not require the server to advance the payment and does not occupy funds.

In the technical solution provided in this example of the present disclosure, the terminal performs the public transit payment operation based on the credit line of the public transit credit card, the consumption bills of various virtual public transit cards are sent by the transportation card management devices to the server, and the server sends the public transit credit bill to the terminal so as to remind the user to pay off the public transit credit bill, thereby realizing that each virtual public transit card associated with the public transit credit card can be directly used without being recharged. Therefore, the user only needs to pay off the public transit credit bill in time, thereby avoiding idle or waste of funds, simplifying operations of the user and improving user experience.

FIG. 4 is a flow chart showing a public transit payment method according to an example, and an execution subject of the method may be a transportation card management device. As shown in FIG. 4, the method includes the following steps 401 and 402.

In step 401, a consumption amount corresponding to a public transit payment operation which is performed by a user with a first virtual public transit card associated with a public transit credit card, is recorded in a consumption bill of the first virtual public transit card. The public transit credit card is associated with more than one virtual public transit cards, and all virtual public transit cards that are associated with the public transit credit card share a credit line of the public transit credit card.

In step 402, the consumption bill of the first virtual public transit card is sent to a server.

In the technical solution provided in this example of the present disclosure, the transportation card management devices send the consumption bills of the various virtual public transit cards to the server, and the server sends a public transit credit bill to the terminal so as to remind the user to pay off the public transit credit bill, thereby realizing that each virtual public transit card associated with the public transit credit card can be directly used without being recharged. Therefore, the user only needs to pay off the public transit credit bill in time, thereby avoiding idle or waste of funds, simplifying operations of the user and improving user experience.

Credit modes of the public transit credit card provided in the present disclosure at least may include a simple credit mode and a full credit mode. Implementation processes in the simple credit mode and the full credit mode of the public transit credit card are described hereinafter, respectively.

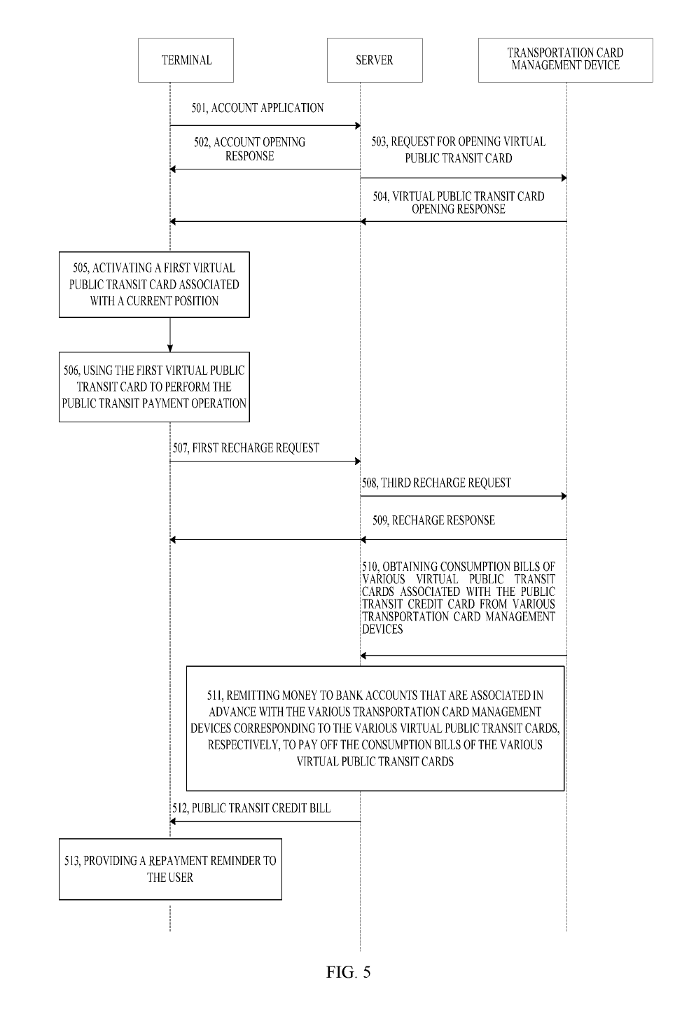

FIG. 5 is a flow chart showing a public transit payment method according to an example, and the method is implemented by a terminal, a server and a transportation card management device. Different virtual public transit cards may be corresponding to different transportation card management devices. FIG. 5 only schematically shows one transportation card management device, but in practice, one or more transportation card management devices may be included. As shown in FIG. 5, the method relates to the full credit mode of the public transit credit card, and includes the following steps.

In step 501, a terminal sends an account application to a server. The account application is used to request the server to open a public transit credit card for the terminal.

As an example, after the server receives the account application, the server acquires the user's avatar and credit records and issues a virtual public transit credit card, i.e., a public transit credit card, for the user, and grants a certain credit line to the public transit credit card. The server sends an account opening response to the terminal, and the account opening response includes the credit line granted by the server to the public transit credit card.

In step 502, the server sends an account opening response to the terminal, the terminal receives the account opening response returned from the server and parses the account opening response to obtain the public transit credit card and its credit line.

In step 503, after the server issues the public transit credit card for a user, the server applies to one transportation card management device to open a virtual public transit card for the user, and the server sends a request for opening virtual public transit card to the transportation card management device.

As an example, the server may only open the virtual public transit card of a city where the user is about to arrive or a city where the user often goes. For the user, the server may also open virtual public transit cards of all cities supported by the server or connected with the server. For example, the server sends the request for opening virtual public transit card to the transportation card management device of each city, to request the transportation card management devices to open the virtual public transit cards for the user.

In step 504, the transportation card management device sends a virtual public transit card opening response to the terminal via the server. The virtual public transit card opening response includes an identifier of the virtual public transit card.

In step 505, the terminal activates a first virtual public transit card associated with a current position.

In step 506, the terminal uses the first virtual public transit card to perform the public transit payment operation, so that the transportation card management device corresponding to the first virtual public transit card records a consumption amount corresponding to the public transit payment operation in a consumption bill of the first virtual public transit card.

In step 507, when a balance of the first virtual public transit card is less than a preset balance threshold, the terminal sends a first recharge request carrying an identifier of the first virtual public transit card to the server. The first recharge request is used to instruct the server to perform a recharge operation based on the credit line of the public transit credit card.

In step 508, according to the identifier of the first virtual public transit card, when the server recognizes that a credit mode of the public transit credit card is a full credit mode and when an available credit line of the public transit credit card is greater than a preset credit line threshold, the server sends a third recharge request to the transportation card management device corresponding to the first virtual public transit card. The third recharge request includes the identifier of the first virtual public transit card.

In step 509, the transportation card management device receives the third recharge request sent from the server, and sends a recharge response carrying the identifier of the first virtual public transit card to the terminal when the transportation card management device determines that the credit mode of the public transit credit card is the full credit mode according to the identifier of the first virtual public transit card.

In step 510, the server obtains consumption bills of various virtual public transit cards associated with the public transit credit card from various transportation card management devices. These consumption bills are obtained by the various transportation card management devices by means of collecting swiping card data of public transit clearing devices such as auto gates.

In step 511, when the credit mode of the public transit credit card is the full credit mode, the server remits money to bank accounts that are associated in advance with the various transportation card management devices corresponding to the various virtual public transit cards, respectively, to pay off the consumption bills of the various virtual public transit cards.

In step 512, the server sends a public transit credit bill to the terminal. The public transit credit bill includes the consumption bills of all virtual public transit cards that are associated with the public transit credit card.

In step 513, the terminal receives the public transit credit bill sent from the server, and provides a repayment reminder to the user, wherein the repayment reminder is used to remind the user to remit money to a bank account that is associated with the server in advance, so as to pay off the public transit credit bill.

In the technical solution provided in this example of the present disclosure, implementation process in the full credit mode of the public transit credit card is illustrated. Based on the full credit mode of the public transit credit card, when it is needed to recharge the virtual public transit cards, the user is not required to pay in real time, the server is not required to advance the payment, and the server requests the transportation card management devices to recharge the virtual public transit cards. Then, when the server receives the consumption bills of the virtual public transit cards sent from the transportation card management devices, the server remits money to the bank accounts that are associated in advance with the transportation card management devices, to pay off the consumption bills of the virtual public transit cards, thereby avoiding idle or waste of funds, and simplifying operations of the user.

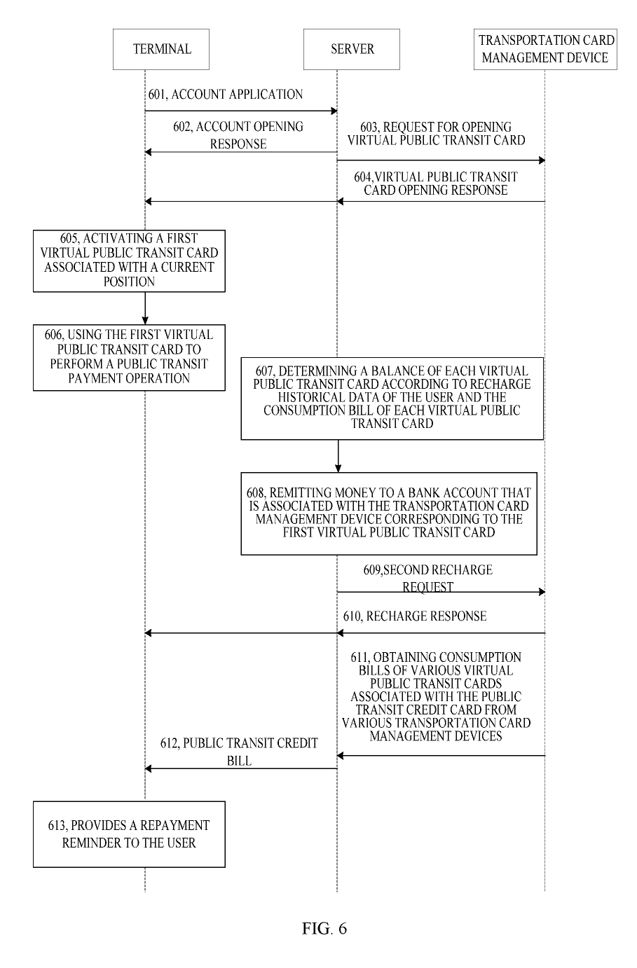

FIG. 6 is a flow chart showing a public transit payment method according to an example, and the method is implemented by a terminal, a server and a transportation card management device. As shown in FIG. 6, the method relates to the simple credit mode of the public transit credit card, and includes the following steps.

In step 601, a terminal sends an account application to a server. The account application is used to request the server to open a public transit credit card for the terminal.

In step 602, the server sends an account opening response to the terminal, and the terminal parses the account opening response to obtain the public transit credit card and its credit line.

In step 603, after the server issues the public transit credit card for a user, the server applies to one transportation card management device to open a virtual public transit card for the user, and the server sends a request for opening virtual public transit card to the transportation card management device.

As an example, the server may only open the virtual public transit card of a city where the user is about to arrive or a city where the user often goes. For the user, the server may also open virtual public transit cards of all cities supported by the server or connected with the server. For example, the server sends the request for opening virtual public transit card to the transportation card management device of each city, to request the transportation card management devices to open the virtual public transit cards for the user.

In step 604, the transportation card management device sends a virtual public transit card opening response to the terminal via the server. The virtual public transit card opening response includes an identifier of the virtual public transit card.

In step 605, the terminal activates a first virtual public transit card associated with a current position.

In step 606, the terminal uses the first virtual public transit card to perform a public transit payment operation, so that the transportation card management device corresponding to the first virtual public transit card records a consumption amount corresponding to the public transit payment operation in a consumption bill of the first virtual public transit card.

In step 607, the server determines a balance of each virtual public transit card according to recharge historical data of the user and the consumption bill of each virtual public transit card.

In step 608, when the balance of the first virtual public transit card is less than a preset balance threshold and it is recognized that a credit mode of the public transit credit card is a simple credit mode according to the identifier of the first virtual public transit card, and when an available credit line of the public transit credit card is greater than a preset credit line threshold, the server remits money to a bank account that is associated with the transportation card management device corresponding to the first virtual public transit card.

In step 609, the server sends a second recharge request to the transportation card management device corresponding to the first virtual public transit card, and the second recharge request includes a remittance voucher and an identifier of the first virtual public transit card.

In step 610, the transportation card management device receives the second recharge request sent from the server, and sends a recharge response carrying the identifier of the first virtual public transit card to the terminal when it is recognized that the credit mode of the public transit credit card is the simple credit mode according to the identifier of the first virtual public transit card and/or the remittance voucher.

In step 611, the server obtains consumption bills of various virtual public transit cards associated with the public transit credit card from various transportation card management devices. These consumption bills are obtained by the various transportation card management devices by means of collecting swiping card data of public transit clearing devices such as auto gates.

In step 612, the server sends a public transit credit bill to the terminal. The public transit credit bill includes the consumption bills of all virtual public transit cards that are associated with the public transit credit card, and is used to remind the user to remit money to a bank account that is associated with the server in advance, so as to pay off the public transit credit bill.

In step 613, the terminal receives the public transit credit bill sent from the server, and provides a repayment reminder to the user, wherein the repayment reminder is used to remind the user to remit money to a bank account that is associated with the server in advance, so as to pay off the public transit credit bill.

In the technical solution provided in this example of the present disclosure, implementation process in the simple credit mode of the public transit credit card is illustrated. Based on the simple credit mode of the public transit credit card, when it is needed to recharge the virtual public transit cards, the user is not required to pay in real time, the server advances the payment, and then the server requests the transportation card management devices to recharge the virtual public transit cards. When the server receives the consumption bills of the virtual public transit cards sent from the transportation card management devices, the server requires the user to pay back money. Therefore, the user does not need to manually recharge the various virtual public transit cards, thereby simplifying operations of the user.

Device examples of the present disclosure are described hereinafter, and can be used to implement the method examples of the present disclosure.

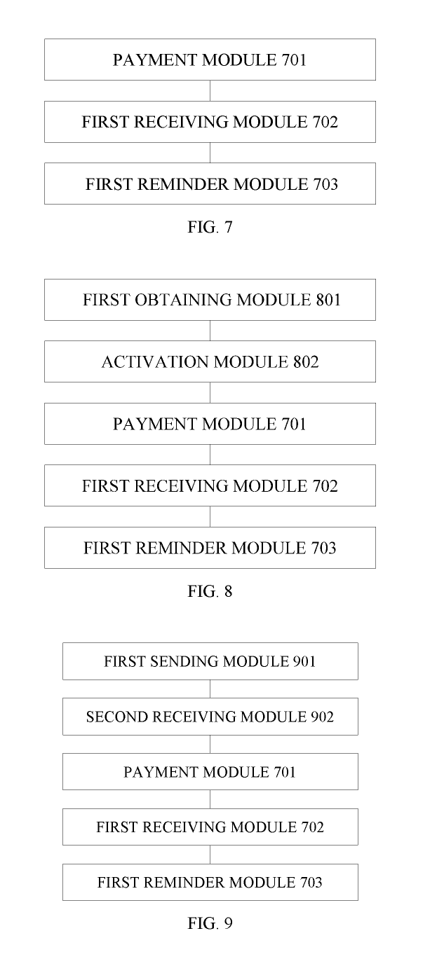

FIG. 7 is a block diagram illustrating a public transit payment device according to an example. The device may be implemented in a variety of manners. For example, all components of the device may be implemented in the terminal, or, the components of the device may be implemented in a coupled manner at the terminal side. The device may implement the above method of the present disclosure through software, hardware or a combination thereof. As shown in FIG. 7, the public transit payment device includes a payment module 701, a first receiving module 702 and a first reminder module 703.

The payment module 701 is configured to perform a public transit payment operation based on a credit line of a public transit credit card. The public transit credit card is associated with more than one virtual public transit cards, and all virtual public transit cards that are associated with the public transit credit card share the credit line of the public transit credit card.

The first receiving module 702 is configured to receive a public transit credit bill sent from a server. The public transit credit bill includes consumption bills of all virtual public transit cards that are associated with the public transit credit card.

The first reminder module 703 is configured to provide a repayment reminder to a user. The repayment reminder is used to remind the user to remit money to a bank account that is associated with the server in advance, so as to pay off the public transit credit bill.

The device provided in this example of the present disclosure can be used to perform the technical solution of the example shown in FIG. 2, their performing manners and beneficial effects are similar and will not be elaborated herein.

In one possible implementation, the payment module 701 uses a first virtual public transit card associated with the public transit credit card to perform the public transit payment operation, so that the transportation card management device corresponding to the first virtual public transit card records a consumption amount corresponding to the public transit payment operation in a consumption bill of the first virtual public transit card.

In one possible implementation, as shown in FIG. 8, the public transit payment device shown in FIG. 7 may further include a first obtaining module 801 and an activation module 802.

The first obtaining module 801 is configured to obtain a current position.

The activation module 802 is configured to activate the first virtual public transit card. The first virtual public transit card is associated with the current position.

In one possible implementation, as shown in FIG. 9, the public transit payment device shown in FIG. 7 may further include a first sending module 901 and a second receiving module 902.

The first sending module 901 is configured to, when a balance of the first virtual public transit card is less than a preset balance threshold, send a first recharge request carrying an identifier of the first virtual public transit card to the server. The first recharge request is used to instruct the server to perform a recharge operation based on the credit line of the public transit credit card.

The second receiving module 902 is configured to receive a recharge response for the first virtual public transit card.

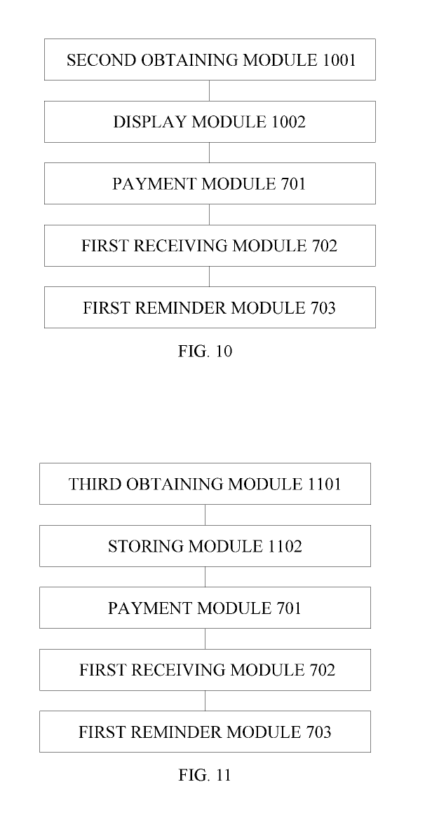

In one possible implementation, as shown in FIG. 10, the public transit payment device shown in FIG. 7 may further include a second obtaining module 1001 and a display module 1002.

The second obtaining module 1001 is configured to obtain pre-configured unified card face information.

The display module 1002 is configured to display the public transit credit card according to the unified card face information. More than one virtual public transit cards associated with the public transit credit card are stored locally.

In one possible implementation, as shown in FIG. 11, the public transit payment device shown in FIG. 7 may further include a third obtaining module 1101 and a storing module 1102.

The third obtaining module 1101 is configured to obtain address information of the user. The address information is associated with the user's historical activity trajectory or the user's schedule.

The storing module 1102 is configured to obtain and store the virtual public transit card associated with the address information according to the address information.

In one possible implementation, as shown in FIG. 12, the public transit payment device shown in FIG. 7 may further include a second reminder module 1201 which is configured to provide a credit line reminder to the user when determining that an available credit line of the public transit credit card is less than a credit line threshold. The credit line reminder is used to remind the user to apply to the server for a higher credit line.

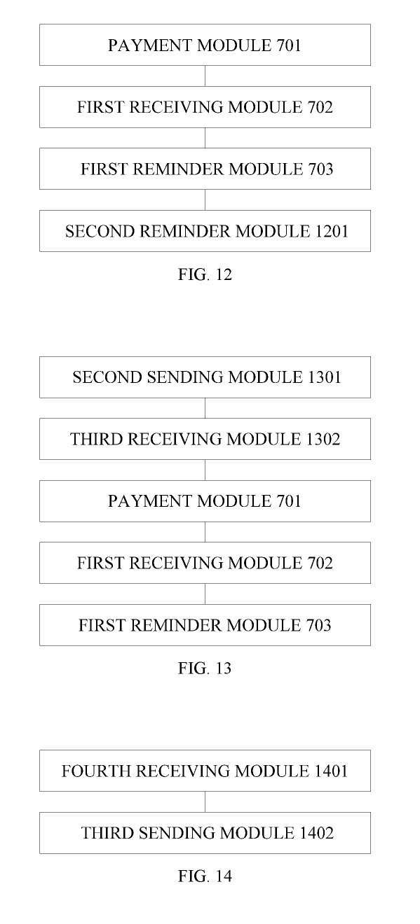

In one possible implementation, as shown in FIG. 13, the public transit payment device shown in FIG. 7 may further include a second sending module 1301 and a third receiving module 1302.

The second sending module 1301 is configured to send an account application to the server. The account application is used to request the server to open the public transit credit card for the terminal.

The third receiving module 1302 is configured to receive an account opening response returned from the server. The account opening response includes the credit line granted by the server to the public transit credit card.

FIG. 14 is a block diagram illustrating a public transit payment device according to an example. The device may be implemented in a variety of manners. For example, all components of the device may be implemented in a server, or, the components of the device may be implemented in a coupled manner at the server side. The device may implement the above method of the present disclosure through software, hardware or a combination thereof. As shown in FIG. 14, the public transit payment device includes a fourth receiving module 1401 and a third sending module 1402.

The fourth receiving module 1401 is configured to receive consumption bills of various virtual public transit cards sent from transportation card management devices which are corresponding to more than one virtual public transit cards, respectively. A public transit credit card is associated with the various virtual public transit cards, and all virtual public transit cards that are associated with the public transit credit card share a credit line of the public transit credit card.

The third sending module 1402 is configured to send a public transit credit bill to the terminal. The public transit credit bill includes consumption bills of all virtual public transit cards that are associated with the public transit credit card, and is used to remind the user to remit money to a bank account that is associated with the server in advance, so as to pay off the public transit credit bill.

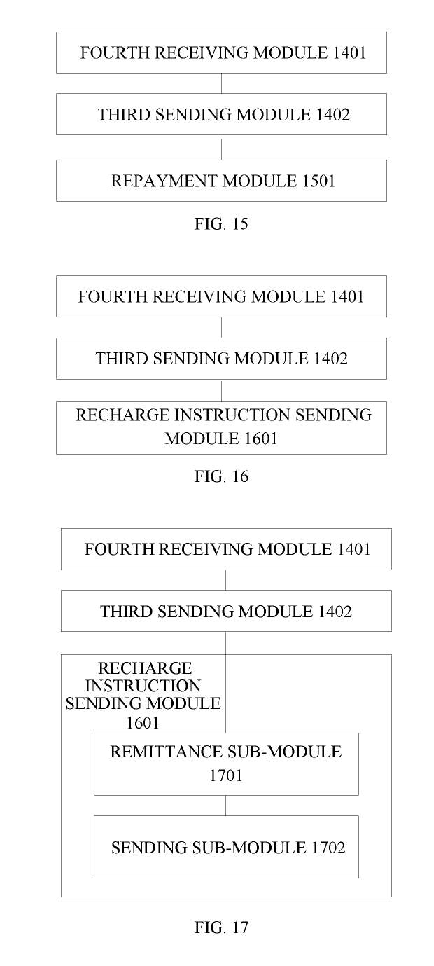

In one possible implementation, as shown in FIG. 15, the public transit payment device shown in FIG. 14 may further include a repayment module 1501 configured to, after receiving the consumption bills of various virtual public transit cards sent from transportation card management devices which are corresponding to more than one virtual public transit cards, respectively, when a credit mode of the public transit credit card is a full credit mode, remit money to bank accounts that are associated in advance with the various transportation card management devices corresponding to the various virtual public transit cards, respectively, to pay off the consumption bills of the various virtual public transit cards.

In one possible implementation, as shown in FIG. 16, the public transit payment device shown in FIG. 14 may further include a recharge instruction sending module 1601 configured to, when determining that the balance of the first virtual public transit card associated with the public transit credit card is less than a preset balance threshold and the available credit line of the public transit credit card is greater than a preset credit line threshold, send a recharge instruction to the transportation card management device corresponding to the first virtual public transit card. The recharge instruction is used to instruct the transportation card management device to send a recharge response to the terminal.

In one possible implementation, as shown in FIG. 17, the recharge instruction sending module 1601 of the public transit payment device shown in FIG. 16 may be configured to include a remittance sub-module 1701 and a sending sub-module 1702.

The remittance sub-module 1701 is configured to, when the credit mode of the public transit credit card is a simple credit mode and the available credit line of the public transit credit card is greater than a preset credit line threshold, remit money to a bank account that is associated with the transportation card management device corresponding to the first virtual public transit card.

The sending sub-module 1702 is configured to send a second recharge request to the transportation card management device corresponding to the first virtual public transit card. The second recharge request includes a remittance voucher and an identifier of the first virtual public transit card.

In one possible implementation, the recharge instruction sending module 1601 sends a third recharge request to the transportation card management device corresponding to the first virtual public transit card when the credit mode of the public transit credit card is the full credit mode. The third recharge request includes an identifier of the first virtual public transit card.

In one possible implementation, the recharge instruction sending module 1601 determines that the balance of the first virtual public transit card is less than the preset balance threshold when it receives from the terminal the first recharge request carrying the identifier of the first virtual public transit card.

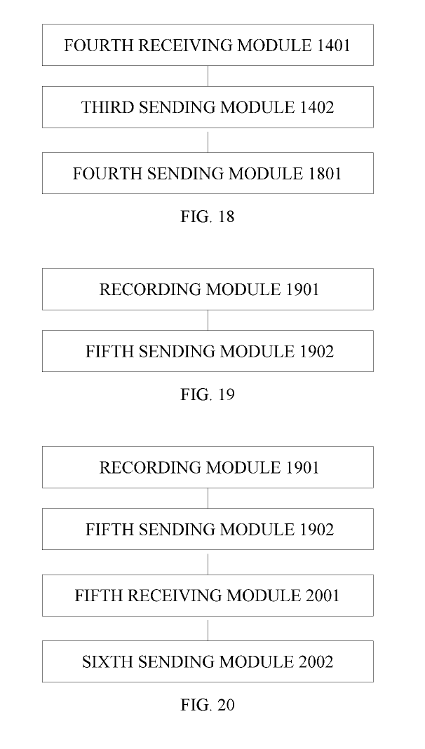

In one possible implementation, as shown in FIG. 18, the public transit payment device shown in FIG. 14 may further include a fourth sending module 1801 configured to send a credit line reminder to the terminal when determining that the available credit line of the public transit credit card is less than the preset credit line threshold. The credit line reminder is used to remind the user to apply to the server for a higher credit line.

FIG. 19 is a block diagram illustrating a public transit payment device according to an example. The device may be implemented in a variety of manners. For example, all components of the device may be implemented in a transportation card management device, or, the components of the device may be implemented in a coupled manner at the transportation card management device side. The device may implement the above method of the present disclosure through software, hardware or a combination thereof. As shown in FIG. 19, the public transit payment device includes a recording module 1901 and a fifth sending module 1902.

The recording module 1901 is configured to record a consumption amount corresponding to a public transit payment operation which is performed by a user with a first virtual public transit card associated with a public transit credit card, in a consumption bill of the first virtual public transit card. The public transit credit card is associated with more than one virtual public transit cards, and all virtual public transit cards that are associated with the public transit credit card share a credit line of the public transit credit card.

The fifth sending module 1902 is configured to send the consumption bill of the first virtual public transit card to a server.

In one possible implementation, as shown in FIG. 20, the public transit payment device shown in FIG. 19 may further include a fifth receiving module 2001 and a sixth sending module 2002.

The fifth receiving module 2001 is configured to receive a third recharge request sent from the server. The third recharge request includes an identifier of the first virtual public transit card.

The sixth sending module 2002 is configured to, when determining that a credit mode of the public transit credit card is a full credit mode according to the identifier of the first virtual public transit card, send a recharge response carrying the identifier of the first virtual public transit card to the terminal.

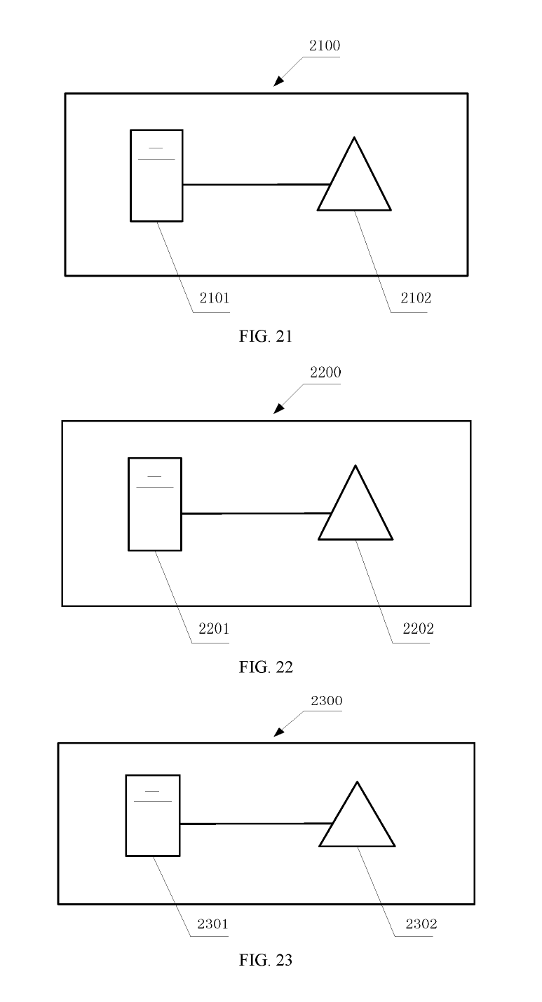

FIG. 21 is a block diagram illustrating a public transit payment device 2100 according to an example. The public transit payment device 2100 may be implemented in a variety of manners. For example, all components of the device may be implemented in a terminal, or, the components of the device may be implemented in a coupled manner at the terminal side. The public transit payment device 2100 includes:

a processor 2101, and

a memory 2102 configured to store instructions executable by the processor.

The processor 2101 is configured to,

perform a public transit payment operation based on a credit line of a public transit credit card, wherein the public transit credit card is associated with more than one virtual public transit cards and all virtual public transit cards that are associated with the public transit credit card share the credit line of the public transit credit card,

receive a public transit credit bill sent from a server, wherein the public transit credit bill includes consumption bills of all virtual public transit cards that are associated with the public transit credit card, and

provide a repayment reminder to a user, wherein the repayment reminder is used to remind the user to remit money to a bank account that is associated with the server in advance, so as to pay off the public transit credit bill.

In one example, the above processor 2101 is further configured to, use a first virtual public transit card associated with the public transit credit card to perform a public transit payment operation, so that the transportation card management device corresponding to the first virtual public transit card records a consumption amount corresponding to the public transit payment operation in a consumption bill of the first virtual public transit card.

In one example, the above processor 2101 is further configured to,

obtain a current position, and

activate the first virtual public transit card, wherein the first virtual public transit card is associated with the current position.

In one example, the above processor 2101 is further configured to,

when a balance of the first virtual public transit card is less than a preset balance threshold, send a first recharge request carrying an identifier of the first virtual public transit card to the server, wherein the first recharge request is used to instruct the server to perform a recharge operation based on the credit line of the public transit credit card, and

receive a recharge response for the first virtual public transit card.

In one example, the above processor 2101 is further configured to,

obtain pre-configured unified card face information, and

display the public transit credit card according to the unified card face information, wherein more than one virtual public transit cards associated with the public transit credit card are stored locally.

In one example, the above processor 2101 is further configured to,

obtain address information of the user, wherein the address information is associated with the user's historical activity trajectory or the user's schedule, and

obtain and store the virtual public transit card associated with the address information according to the address information.

In one example, the above processor 2101 is further configured to, provide a credit line reminder to the user when determining that an available credit line of the public transit credit card is less than a credit line threshold, wherein the credit line reminder is used to remind the user to apply to the server for a higher credit line.

In one example, the above processor 2101 is further configured to,

send an account application to the server, wherein the account application is used to request the server to open the public transit credit card for the terminal, and

receive an account opening response returned from the server, wherein the account opening response includes the credit line granted by the server to the public transit credit card.

FIG. 22 is a block diagram illustrating a public transit payment device 2200 according to an example. The public transit payment device 2200 may be implemented in a variety of manners. For example, all components of the device may be implemented in a server, or, the components of the device may be implemented in a coupled manner at the server side. The public transit payment device 2200 includes:

a processor 2201, and

a memory 2202 configured to store instructions executable by the processor.

The processor 2201 is configured to,

receive consumption bills of various virtual public transit cards sent from transportation card management devices which are corresponding to more than one virtual public transit cards, respectively, wherein a public transit credit card is associated with the various virtual public transit cards and all virtual public transit cards that are associated with the public transit credit card share a credit line of the public transit credit card, and

send a public transit credit bill to the terminal, wherein the public transit credit bill includes consumption bills of all virtual public transit cards that are associated with the public transit credit card and is used to remind the user to remit money to a bank account that is associated with the server in advance, so as to pay off the public transit credit bill.

In one example, the above processor 2201 is further configured to, when a credit mode of the public transit credit card is a full credit mode, remit money to bank accounts that are associated in advance with the various transportation card management devices corresponding to the various virtual public transit cards, respectively, to pay off the consumption bills of the various virtual public transit cards.

In one example, the above processor 2201 is further configured to, when determining that the balance of the first virtual public transit card associated with the public transit credit card is less than a preset balance threshold and the available credit line of the public transit credit card is greater than a preset credit line threshold, send a recharge instruction to the transportation card management device corresponding to the first virtual public transit card. The recharge instruction is used to instruct the transportation card management device to send a recharge response to the terminal.

In one example, the above processor 2201 is further configured to,

when the credit mode of the public transit credit card is a simple credit mode, remit money to a bank account that is associated with the transportation card management device corresponding to the first virtual public transit card, and

send a second recharge request to the transportation card management device corresponding to the first virtual public transit card, wherein the second recharge request includes a remittance voucher and an identifier of the first virtual public transit card.

In one example, the above processor 2201 is further configured to, sends a third recharge request to the transportation card management device corresponding to the first virtual public transit card when the credit mode of the public transit credit card is the full credit mode, wherein the third recharge request includes an identifier of the first virtual public transit card.

In one example, the above processor 2201 is further configured to, determine that the balance of the first virtual public transit card is less than the preset balance threshold when receiving from the terminal the first recharge request carrying the identifier of the first virtual public transit card.

In one example, the above processor 2201 is further configured to, send a credit line reminder to the terminal when determining that the available credit line of the public transit credit card is less than the preset credit line threshold, wherein the credit line reminder is used to remind the user to apply to the server for a higher credit line.

FIG. 23 is a block diagram illustrating a public transit payment device 2300 according to an example. The public transit payment device 2300 may be implemented in a variety of manners. For example, all components of the device may be implemented in a transportation card management device, or, the components of the device may be implemented in a coupled manner at the transportation card management device side. The public transit payment device 2300 includes:

a processor 2301, and

a memory 2302 configured to store instructions executable by the processor.

The processor 2301 is configured to,

record a consumption amount corresponding to a public transit payment operation which is performed by a user with a first virtual public transit card associated with a public transit credit card, in a consumption bill of the first virtual public transit card, wherein the public transit credit card is associated with more than one virtual public transit cards and all virtual public transit cards that are associated with the public transit credit card share a credit line of the public transit credit card, and

send the consumption bill of the first virtual public transit card to a server.

In one example, the above processor 2301 is further configured to,

receive a third recharge request sent from the server, wherein the third recharge request includes an identifier of the first virtual public transit card, and

when determining that a credit mode of the public transit credit card is a full credit mode according to the identifier of the first virtual public transit card, send a recharge response carrying the identifier of the first virtual public transit card to the terminal.

With respect to the devices in the above examples, the specific manners for performing operations in individual modules therein have been described in detail in the examples regarding the related methods and will not be elaborated herein.

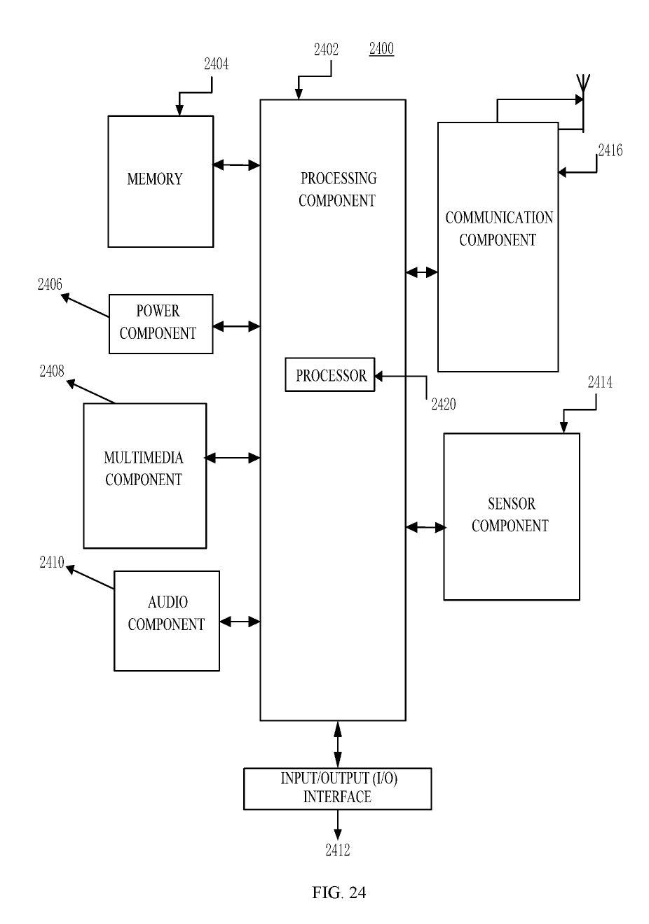

FIG. 24 is a block diagram illustrating a public transit payment device according to an example. For example, the public transit payment device 2400 may be a smart phone, a tablet computer, a wearable device or the like.

Referring to FIG. 24, the public transit payment device 2400 may include one or more of the following components: a processing component 2402, a memory 2404, a power component 2406, a multimedia component 2408, an audio component 2410, an input/output (I/O) interface 2412, a sensor component 2414 and a communication component 2416.

The processing component 2402 typically controls overall operations of the public transit payment device 2400, such as the operations associated with display, phone calls, data communications, camera operations and recording operations. The processing component 2402 may include one or more processors 2420 to execute instructions to perform all or part of the steps in the above described methods. Moreover, the processing component 2402 may include one or more modules which facilitate the interaction between the processing component 2402 and other components. For example, the processing component 2402 may include a multimedia module to facilitate the interaction between the multimedia component 2408 and the processing component 2402.

The memory 2404 is configured to store various types of data to support operations of the public transit payment device 2400. Examples of such data include instructions for any applications or methods operated on the public transit payment device 2400, contact data, phonebook data, messages, pictures, video, etc. The memory 2404 may be implemented by using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 2406 provides power to various components of the public transit payment device 2400. The power component 2406 may include a power supply management system, one or more power sources, and any other components associated with the generation, management, and distribution of power in the public transit payment device 2400.

The multimedia component 2408 includes a screen providing an output interface between the public transit payment device 2400 and the user. In some examples, the screen may include a liquid crystal display (LCD) and a touch panel (TP). If the screen includes the touch panel, the screen may be implemented as a touch screen to receive input signals from the user. The touch panel includes one or more touch sensors to sense touches, swipes and gestures on the touch panel. The touch sensors may not only sense a boundary of a touch or swipe action, but also sense a period of time and a pressure associated with the touch or swipe action. In some examples, the multimedia component 2408 includes a front camera and/or a rear camera. The front camera and/or the rear camera may receive an external multimedia datum while the public transit payment device 2400 is in an operation mode, such as a photographing mode or a video mode. Each of the front camera and the rear camera may be a fixed optical lens system or have focus and optical zoom capability.

The audio component 2410 is configured to output and/or input audio signals. For example, the audio component 2410 includes a microphone (MIC) configured to receive an external audio signal when the public transit payment device 2400 is in an operation mode, such as a call mode, a recording mode, and a voice recognition mode. The received audio signal may be further stored in the memory 2404 or transmitted via the communication component 2416. In some examples, the audio component 2410 further includes a speaker to output audio signals.

The I/O interface 2412 provides an interface between the processing component 2402 and peripheral interface modules, such as a keyboard, a click wheel, buttons, and the like. The buttons may include, but are not limited to, a home button, a volume button, a starting button, and a locking button.

The sensor component 2414 includes one or more sensors to provide status assessments of various aspects of the public transit payment device 2400. For instance, the sensor component 2414 may detect an open/closed status of the public transit payment device 2400, relative positioning of components, e.g., the display and the keypad, of the public transit payment device 2400, a change in position of the public transit payment device 2400 or a component of the public transit payment device 2400, a presence or absence of user's contact with the public transit payment device 2400, an orientation or an acceleration/deceleration of the public transit payment device 2400, and a change in temperature of the public transit payment device 2400. The sensor component 2414 may include a proximity sensor configured to detect the presence of nearby objects without any physical contact. The sensor component 2414 may also include a light sensor, such as a CMOS or CCD image sensor, for use in imaging applications. In some examples, the sensor component 2414 may also include an accelerometer sensor, a gyroscope sensor, a magnetic sensor, a pressure sensor or a temperature sensor.

The communication component 2416 is configured to facilitate communication, wired or wirelessly, between the public transit payment device 2400 and other devices. The public transit payment device 2400 can access a wireless network based on a communication standard, such as WiFi, 2G, or 3G, or a combination thereof. In one example, the communication component 2416 receives a broadcast signal or broadcast associated information from an external broadcast management system via a broadcast channel. In one example, the communication component 2416 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In examples, the public transit payment device 2400 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above methods.

In an example, there is also provided a non-transitory computer-readable storage medium including instructions, such as included in the memory 2404, executable by the processor 2420 in the public transit payment device 2400, for performing the above-described methods. For example, the non-transitory computer-readable storage medium may be a ROM, a RAM, a CD-ROM, a magnetic tape, a floppy disc, an optical data storage device, and the like.

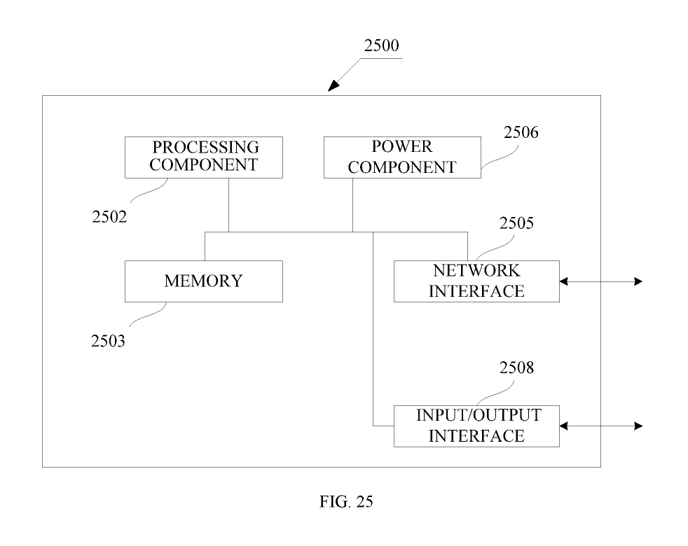

FIG. 25 is a block diagram illustrating a public transit payment device according to an example. For example, the public transit payment device 2500 may be implemented as a server. The public transit payment device 2500 includes a processing component 2502 which further includes one or more processors, and memory resources represented by a memory 2503 for storing instructions executable by the processing component 2502, such as applications. The applications stored in the memory 2503 may include one or more modules, each corresponding to a set of instructions. In addition, the processing component 2502 is configured to execute instructions to perform the above method.

The public transit payment device 2500 may further include a power component 2506 configured to perform power supply management of the public transit payment device 2500, a wired or wireless network interface 2505 configured to connect the public transit payment device 2500 to the network, and an input/output interface 2508. The public transit payment device 2500 may operate an operating system stored in the memory 2503, such as Windows Server™, Mac OS X™, Unix™, Linux™, FreeBSD™ or the like.

The present disclosure may include dedicated hardware implementations such as application specific integrated circuits, programmable logic arrays and other hardware devices. The hardware implementations can be constructed to implement one or more of the methods described herein. Applications that may include the apparatus and systems of various examples can broadly include a variety of electronic and computing systems. One or more examples described herein may implement functions using two or more specific interconnected hardware modules or devices with related control and data signals that can be communicated between and through the modules, or as portions of an application-specific integrated circuit. Accordingly, the computing system disclosed may encompass software, firmware, and hardware implementations. The terms “module,” “sub-module,” “circuit,” “sub-circuit,” “circuitry,” “sub-circuitry,” “unit,” or “sub-unit” may include memory (shared, dedicated, or group) that stores code or instructions that can be executed by one or more processors.

Other examples of the disclosure will be apparent to those skilled in the art from consideration of the specification and practice of the disclosure disclosed here. This application is intended to cover any variations, uses, or adaptations of the disclosure following the general principles thereof and including such departures from the present disclosure as come within known or customary practice in the art. It is intended that the specification and examples be considered as exemplary only.

It will be appreciated that the present disclosure is not limited to the exact construction that has been described above and illustrated in the accompanying drawings, and that various modifications and changes can be made without departing from the scope thereof

1. A public transit payment device comprising:
a processor, and
a memory configured to store instructions executable by the processor,
wherein the processor is configured to:
perform a public transit payment operation based on a credit line of a public transit credit card, wherein the public transit credit card is associated with more than one virtual public transit cards, and the more than one virtual public transit cards that are associated with the public transit credit card share the credit line of the public transit credit card,
receive a public transit credit bill sent from a server, wherein the public transit credit bill includes consumption bills of the more than one virtual public transit cards that are associated with the public transit credit card, and
create a repayment reminder, wherein the repayment reminder is used to remind to remit money to a bank account that is associated with the server in advance to pay off the public transit credit bill.

2. The device of claim 1, wherein the processor configured to perform the public transit payment operation based on the credit line of the public transit credit card is further configured to:
use a first virtual public transit card associated with the public transit credit card to perform the public transit payment operation such that a transportation card management device corresponding to the first virtual public transit card records a consumption amount corresponding to the public transit payment operation in a consumption bill of the first virtual public transit card.

3. The device of claim 2, wherein the processor is further configured to:
obtain a current position, and
activate the first virtual public transit card wherein the first virtual public transit card is associated with the current position.

4. The device of claim 2, wherein the processor is further configured to:
when a balance of the first virtual public transit card is less than a preset balance threshold, send a first recharge request carrying an identifier of the first virtual public transit card to the server,
wherein the first recharge request is used to instruct the server to perform a recharge operation based on the credit line of the public transit credit card, and
receive a recharge response for the first virtual public transit card.

5. The device of claim 1, wherein the processor is further configured to:
obtain pre-configured unified card face information, and
display the public transit credit card according to the unified card face information, wherein the more than one virtual public transit cards associated with the public transit credit card are stored locally.

6. The device of claim 5, wherein the processor is further configured to:
obtain address information of a user, wherein the address information is associated with user's historical activity trajectory or user's schedule, and
obtain and store the virtual public transit card associated with the address information according to the address information.

7. The device of claim 1, wherein the processor is further configured to:
provide a credit line reminder to a user when determining that an available credit line of the public transit credit card is less than a credit line threshold, wherein the credit line reminder is used to remind the user to apply to the server for a higher credit line.

8. The device of claim 1, wherein the processor is further configured to:
send an account application to the server, wherein the account application is used to request the server to open the public transit credit card for the terminal, and
receive an account opening response returned from the server, wherein the account opening response includes the credit line granted by the server to the public transit credit card.

9. A public transit payment device comprising:
a processor, and
a memory configured to store instructions executable by the processor,
wherein the processor is configured to:
receive consumption bills of virtual public transit cards sent from transportation card management devices, wherein each of the transportation card management devices corresponds to one virtual public transit card, and a public transit credit card is associated with the virtual public transit cards and the virtual public transit cards that are associated with the public transit credit card share a credit line of the public transit credit card, and
send a public transit credit bill to a terminal, wherein the public transit credit bill comprises the consumption bills of the virtual public transit cards that are associated with the public transit credit card and is used to remind to remit money to a bank account that is associated with a server in advance to pay off the public transit credit bill.

10. The device of claim 9, wherein, after the consumption bills of the virtual public transit cards sent from the transportation card management devices are received, the processor is further configured to:
when a credit mode of the public transit credit card is a full credit mode, remit money to bank accounts that are associated in advance with the transportation card management devices corresponding to the virtual public transit cards to pay off the consumption bills of the virtual public transit cards.

11. The device of claim 9, wherein the processor is further configured to:
when determining that a balance of a first virtual public transit card associated with the public transit credit card is less than a preset balance threshold and an available credit line of the public transit credit card is greater than a preset credit line threshold, send a recharge instruction to the transportation card management device corresponding to the first virtual public transit card wherein the recharge instruction is used to instruct the transportation card management device to send a recharge response to the terminal.

12. The device of claim 11, wherein the processor configured to send the recharge instruction to the transportation card management device corresponding to the first virtual public transit card is further configured to:
when a credit mode of the public transit credit card is a simple credit mode, remit money to a bank account that is associated with the transportation card management device corresponding to the first virtual public transit card, and
send a second recharge request to the transportation card management device corresponding to the first virtual public transit card wherein the second recharge request comprises a remittance voucher and an identifier of the first virtual public transit card.

13. The device of claim 11, wherein the processor configured to send the recharge instruction to the transportation card management device corresponding to the first virtual public transit card is further configured to:
send a third recharge request to the transportation card management device corresponding to the first virtual public transit card when a credit mode of the public transit credit card is a full credit mode wherein the third recharge request comprises an identifier of the first virtual public transit card.

14. The device of claim 11, wherein the processor configured to determine that the balance of the first virtual public transit card associated with the public transit credit card is less than the preset balance threshold is further configured to:
determine that the balance of the first virtual public transit card is less than the preset balance threshold when a first recharge request carrying an identifier of the first virtual public transit card is received from the terminal.

15. The device of claim 9, wherein the processor is further configured to, send a credit line reminder to the terminal when determining that an available credit line of the public transit credit card is less than a preset credit line threshold wherein the credit line reminder is used to remind to apply to the server for a higher credit line.

16. A public transit payment device comprising:
a processor, and
a memory configured to store instructions executable by the processor,
wherein the processor is configured to:
record a consumption amount, corresponding to a public transit payment operation which is performed using a first virtual public transit card associated with a public transit credit card, in a consumption bill of the first virtual public transit card, wherein the public transit credit card is associated with more than one virtual public transit cards and the more than one virtual public transit cards that are associated with the public transit credit card share a credit line of the public transit credit card, and
send the consumption bill of the first virtual public transit card to a server.

17. The device of claim 16, wherein the processor is further configured to:
receive a recharge request sent from the server, wherein the recharge request comprises an identifier of the first virtual public transit card, and
when determining that a credit mode of the public transit credit card is a full credit mode according to the identifier of the first virtual public transit card, send a recharge response carrying the identifier of the first virtual public transit card to the terminal.
